(19) United States
(12) Patent Application Publication
(10) Pub. No.: US 2024/0369362 A1
(43) Pub. Date: Nov. 7, 2024

(54) MICROMECHANICAL GYROSCOPE AND ELECTRONIC PRODUCT

(71) Applicant: AAC Kaitai Technologies (Wuhan) CO., LTD, Wuhan (CN)

(72) Inventors: Zhao Ma, Wuhan (CN); Shan Yang, Wuhan (CN); Shitao Yan, Wuhan (CN); Zhan Zhan, Wuhan (CN); Xiao Kan, Wuhan (CN); Hongtao Peng, Wuhan (CN); Veronica Tan, Singapore (SG); Yang Li, Wuhan (CN); Kahkeen Lai, Singapore (SG)

(21) Appl. No.: 18/409,757

(22) Filed: Jan. 10, 2024

Related U.S. Application Data
(63) Continuation of application No. PCT/CN2023/092424, filed on May 6, 2023.

(51) Int. Cl. G01C 19/5733; G01C 19/5769; G01C 19/00

(52) U.S. Cl. CPC G01C 19/5733; G01C 19/5769; G01C 19/005

(57) ABSTRACT

Provided are a micromechanical gyroscope and an electronic product. The micromechanical gyroscope includes a first mass, a plurality of second masses, a plurality of first flexible beams and a plurality of second flexible beams. The first mass is provided with a mounting area, the plurality of second masses are distributed in a first direction, and the plurality of drivers are distributed in first direction and disposed on two opposite sides of the plurality of second masses in first direction. The plurality of drivers and the plurality of second masses are all located within the mounting area, and the first mass surrounds outer sides of the plurality of drivers and outer sides of the plurality of second masses. With the micromechanical gyroscope and the electronic product, the coriolis conversion rate of the first mass 1 can be improved, and the utilization of a chip area can be maximized.

### CROSS REFERENCE TO RELATED APPLICATIONS

The present application is a continuation of PCT Patent Application No. PCT/CN2023/092424, filed May 6, 2023, which is incorporated by reference herein in its entirety.

### TECHNICAL FIELD

The present disclosure relates to the technical field of gyroscopes, and in particular, to a micromechanical gyroscope and an electronic product.

### BACKGROUND

A micromechanical gyroscope is a miniature angular velocity sensor manufactured by applying micromachining technologies and microelectronic processes. The micromechanical gyroscope swings around an axis perpendicular to a mass of the micromechanical gyroscope in a drive mode. The micromechanical gyroscope includes an X/Y mass and a Z mass, and when the micromechanical gyroscope is subjected to an angular velocity the micromechanical gyroscope, due to the coriolis effect, the micromechanical gyroscope is brought into a detection mode, enabling out-of-plane swinging of the X/Y mass under a relative drive or in-plane movement of the Z mass under a relative drive, whereby a magnitude of the angular velocity can be obtained by detecting an out-of-plane or in-plane displacement.

In a micromechanical gyroscope in the related art, a Z mass and a driver are arranged on an outer side of a X/Y mass. This results in a low conversion efficiency of the coriolis force of the X/Y mass and a low utilization of the chip area.

Therefore, it is desired to provide a novel micromechanical gyroscope to solve the above problems.

### SUMMARY

The present disclosure provides a micromechanical gyroscope and an electronic product, which is capable of improving the coriolis conversion rate of the first mass and maximizing the utilization of a chip area.

In one aspect, a micromechanical gyroscope is provided. The micromechanical gyroscope includes a first mass, a plurality of second masses, a plurality of drivers, a plurality of first flexible beams and a plurality of second flexible beams. The first mass is provided with a mounting area. The plurality of second masses are distributed in a first direction. The plurality of drivers are distributed in first direction, and a respective driver of a plurality of drivers is disposed on a respective one of two opposite sides of the plurality of second masses in first direction. The plurality of drivers and the plurality of second masses are all located within the mounting area, and the first mass surrounds outer sides of the plurality of drivers and outer sides of the plurality of second masses. The respective driver of the plurality of drivers is connected to the first mass by means of a respective first flexible beam of the plurality of first flexible beams. A respective second mass of the plurality of second masses is connected to the respective driver of the plurality of drivers adjacent to the respective second mass by means of a respective second flexible beam of the plurality of second flexible beams.

As an improvement, in a direction perpendicular to a front surface of the first mass, a projection of the first mass is a centrosymmetric pattern; and the plurality of drivers are symmetrical to each other in the first direction, and the plurality of second masses are symmetrical to each other in the first direction.

As an improvement, the first mass includes a plurality of first motion portions, which are uniformly disposed on the outer sides of the plurality of drivers and the outer sides of the plurality of second masses. Each of the plurality of drivers includes a plurality of driving portions symmetrical to each other in a second direction perpendicular to the first direction, and each of the plurality of second masses includes a plurality of second motion portions symmetrical to each other along the second direction. A respective driving portion of the plurality of driving portions is provided between a respective first motion portion of the plurality of first motion portions and one of the plurality of second motion portions adjacent to the respective first motion portion, the respective driving portion is connected to the respective first motion portion by means of a respective one of the plurality of first flexible beams, and the respective driving portion is connected to the one of the plurality of second motion portions by means of a respective one of the plurality of second flexible beams.

As an improvement, the micromechanical gyroscope further includes a first anchor point, a plurality of second anchor points, a plurality of third anchor points, a plurality of third flexible beams and a plurality of fourth flexible beams. The first anchor point, the plurality of second anchor points and the plurality of third anchor points are all located in the mounting area. The first anchor point and the plurality of second anchor points are disposed between the plurality of second masses, and the plurality of second anchor points are disposed on two opposite sides of the first anchor point in a second direction perpendicular to the first direction. A respective third anchor point of the plurality of third anchor points is disposed on a side of the respective driver of the plurality of drivers facing the respective second mass of the plurality of second masses, and the plurality of third anchor points are disposed opposite to each other in the first direction. The respective second mass of the plurality of second masses is connected to the first anchor point by means of a respective third flexible beam of the plurality of third flexible beams, and the first mass is connected to the plurality of second anchor points and the plurality of third anchor points by means of the plurality of fourth flexible beams.

As an improvement, an avoidance space is provided on a side of the respective second mass of the plurality of second masses facing the respective driver of the plurality of drivers, and the respective third anchor point is located in the avoidance space.

As an improvement, the micromechanical gyroscope further includes a plurality of coupling parts between the plurality of second masses. In the second direction, the plurality of coupling parts are disposed on two opposite sides of the first anchor respectively. The respective second mass of the plurality of second masses is connected to one end of a respective coupling part of the plurality of coupling parts by means of the respective third flexible beam of the plurality of third flexible beams, and another end of the respective coupling part is connected to the first anchor point.

As an improvement, the respective coupling part includes a coupling block and a coupling beam, and the respective second mass of the plurality of second masses is connected to one end of the coupling block by means of the respective third flexible beam, and another end of the coupling block is connected to the first anchor point.

As an improvement, the micromechanical gyroscope further includes a plurality of fourth anchor points and a plurality of guiding beams. The plurality of fourth anchor points are located in the mounting area and distributed in a circumferential direction of the mounting area, a respective fourth anchor point of the plurality of fourth anchor points is disposed between the first mass and the respective driver of the plurality of drivers, and the respective driver is connected to the respective fourth anchor point by means of a respective guiding beam of the plurality of guiding beams.

As an improvement, the micromechanical gyroscope further includes a plurality of in-plane driving transducers, a plurality of in-plane detecting transducers and a plurality of out-of-plane detecting transducers. A respective in-plane driving transducer of the plurality of in-plane driving transducers is disposed above the respective driver of the plurality of drivers. A respective in-plane detecting transducer of the plurality of in-plane detecting transducers is disposed above the respective second mass of the plurality of second masses. The plurality of out-of-plane detecting transducers, disposed above the first mass.

According to an aspect of the present disclosure, an electronic product is further provided. The electronic product includes a body and the above micromechanical gyroscope mounted on the body.

The present disclosure has beneficial effects described below.

In the micromechanical gyroscope and the electronic product, the plurality of drivers and the plurality of second masses are all located in the mounting area provided by the first mass, and the first mass surrounds the outer sides of the plurality of drivers and the outer sides of the plurality of second masses, i.e., arranging the second masses and the drivers in a position where the first mass has a low coriolis conversion rate, thereby improving the coriolis conversion rate of the first mass and maximizing the utilization of a chip area. Thus, under equal performance, a size of the chip is reduced, and the cost is reduced.

### BRIEF DESCRIPTION OF THE DRAWINGS

FIG. 1 is a schematic diagram illustrating a front view of a micromechanical gyroscope in one implementation according to the present disclosure.

FIG. 2 is an enlarged view at part I in FIG. 1.

FIG. 3 is an enlarged view at part II in FIG. 1.

FIG. 4 is an enlarged view at part III in FIG. 1.

FIG. 5 is a front view of FIG. 1 with the addition of an out-of-plane driving transducer, an out-of-plane detecting transducer and an in-plane detecting transducer.

FIG. 6 is a side view of FIG. 5.

FIG. 7 is a schematic structure diagram of the micromechanical gyroscope in a drive mode according to the present disclosure.

FIG. 8 is a schematic structure diagram of the micromechanical gyroscope in a first detection mode according to the present disclosure.

FIG. 9 is a schematic structure diagram of the micromechanical gyroscope in a second detection mode according to the present disclosure.

FIG. 10 is a schematic structure diagram of the micromechanical gyroscope in a third detection mode according to the present disclosure.

Reference list:

| | | | | | |
|---|---|---|---|---|---|
| 1 | first mass | 11 | first motion portion | | |
| 2 | second mass | 21 | second motion portion | 22 | avoidance space |
| 3 | driver | 31 | driving portion | | |
| 41 | first anchor point | 42 | second anchor point | | |
| 43 | third anchor point | 44 | fourth anchor point | | |
| 51 | first flexible beam | 52 | second flexible beam | | |
| 53 | third flexible beam | 54 | fourth flexible beam | | |
| 6 | coupling member | 61 | coupling block | 62 | coupling beam |
| 7 | guiding beam | | | | |
| 81 | in-plane driving transducer | 82 | out-of-plane detecting transducer | | |
| 83 | in-plane detecting transducer | | | | |

### DETAILED DESCRIPTION OF THE EMBODIMENTS

The present disclosure is further described below in conjunction with the accompanying drawings and embodiments.

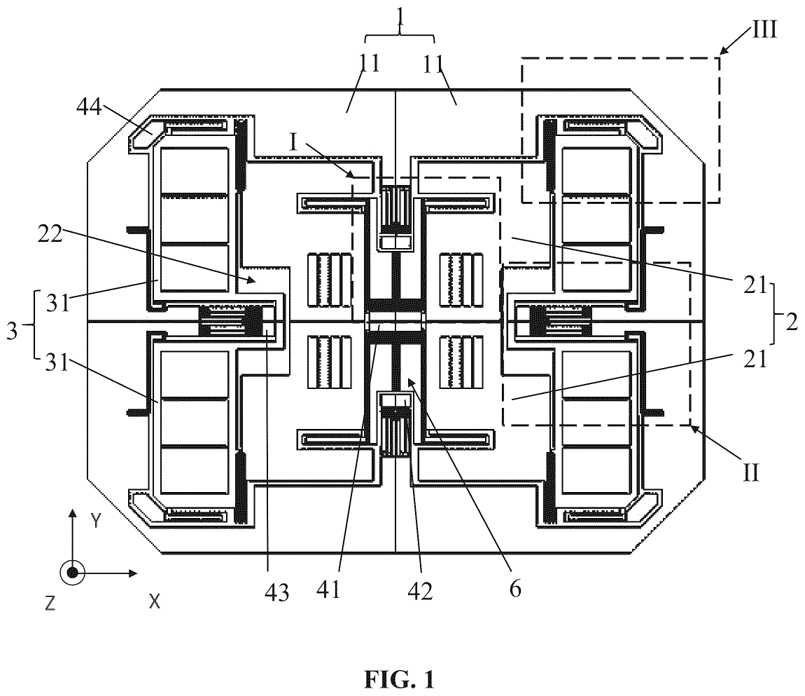

An embodiment of the present disclosure provides a micromechanical gyroscope. As shown in FIG. 1, the micromechanical gyroscope includes a first mass 1, a plurality of second masses 2, a plurality of drivers 3, a plurality of first flexible beams 51 and a plurality of second flexible beams 52. The first mass 1 is provided with a mounting area, and the plurality of second masses 2 are distributed in a first direction X. The plurality of drivers 3 are distributed in the first direction X, and each of two opposite sides of the plurality of second masses 2 in the first direction X is provided with a respective driver of the plurality of drivers 3. The plurality of drivers 3 and the plurality of second masses 2 are all located in the mounting area, and the first mass 1 surrounds outer sides of the plurality of drivers 3 and outer sides of the plurality of second masses 2. A respective driver 3 of the plurality of driver 3 is connected to the first mass 1 by means of a respective first flexible beam 51 of the plurality of first flexible beams 51, and a respective second mass 2 of the plurality of second masses 2 is connected to a driver 3 adjacent to the respective second mass 2 by means of a respective second flexible beam 52 of the plurality of second flexible beams 52.

The micromechanical gyroscope has four operation modes, which are a drive mode, a first detection mode, a second detection mode and a third detection mode. For example, as shown in FIG. 1, one first mass 1 is provided, two second masses 2 are provided, and two drivers 3 are provided. The first direction X denotes a direction where an X-axis is located, a second direction Y denotes a direction where a Y-axis is located, a Z-axis is perpendicular to both the X-axis and the Y-axis, and a plane where the X-axis and the Y-axis are both located is defined as a datum plane. Examples are illustrated as follows.

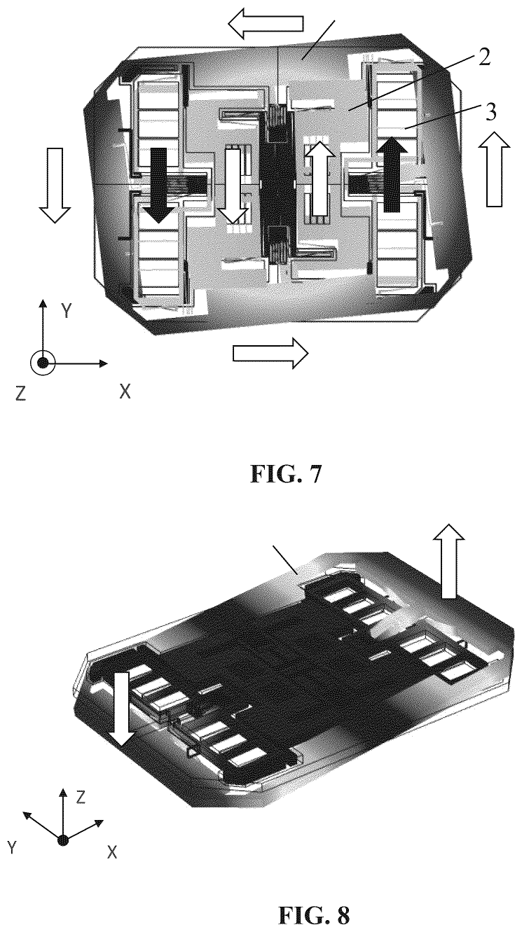

In detecting an angular velocity, the micromechanical gyroscope is first brought into the drive mode. In the drive mode, one of the two drivers 3 moves in the second direction Y, and the other of the two drivers 3 moves in a direction opposite to the second direction Y (the movement directions of the two drivers 3 are shown by black arrows in FIG. 7, for example). At this time, the two drivers 3 drives two second masses 2 adjacent to the two driver 3, respectively, to move toward two opposite directions in the Y-axis, and the two drivers 3 drives the first mass 1 to rotate (movement directions of the first mass 1 and the second masses 2 are shown by white arrows in FIG. 7, for example).

When the micromechanical gyroscope is subjected to an angular velocity in an X-axis direction, and the first mass 1 is subjected to the action of the coriolis force in a Z-axis direction (shown by white arrows in FIG. 8), the first detection mode is triggered, so that on two opposite sides of the first mass 1 in the X-axis direction, the first mass 1 generates out-of-plane vibration displacements in the Z-axis direction (i.e., vibration displacements toward the outside of the datum plane). By detecting the out-of-plane vibration displacements of the first mass 1 in the Z-axis direction on the two opposite sides of the first mass 1 in the X-axis direction, the angular velocity of the micromechanical gyroscope around the X-axis can be obtained.

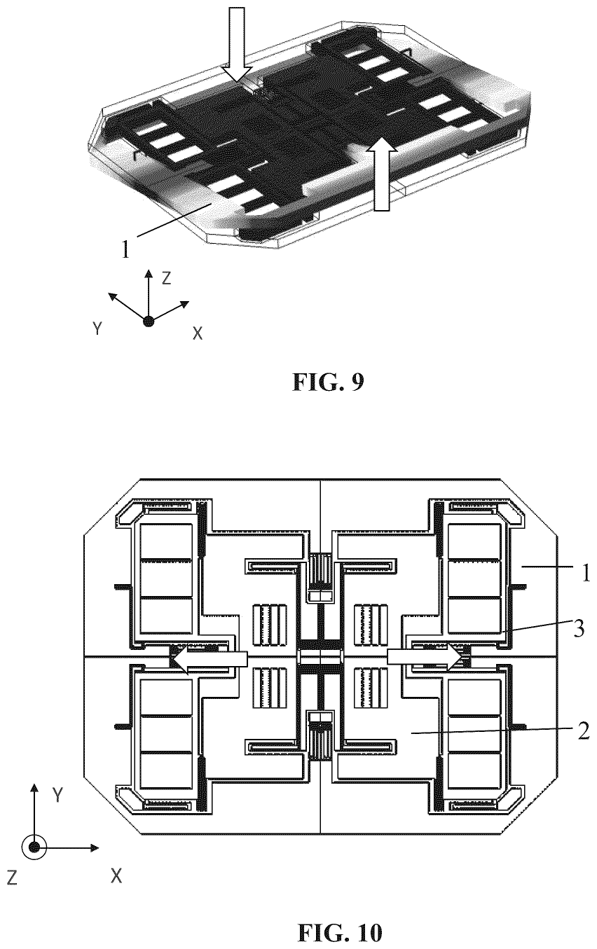

When the micromechanical gyroscope is subjected to an angular velocity in a Y-axis direction, and the first mass 1 is subjected to the action of the coriolis force in the Z-axis direction (shown by white arrows in FIG. 9), the second detection mode is triggered, so that on two opposite sides of the first mass 1 in the Y-axis direction, the first mass 1 generates out-of-plane vibration displacements in the Z-axis direction (i.e., vibration displacements toward the outside of the datum plane). By detecting the out-of-plane vibration displacements of the first mass 1 in the Z-axis direction on the two opposite sides of the first mass 1 in the Y-axis direction, the angular velocity of the micromechanical gyroscope around the Y-axis can be obtained.

When the micromechanical gyroscope is subjected to an angular velocity in the Z-axis direction, and each second mass 2 is subjected to the action of the coriolis force in the X-axis direction (shown by white arrows in FIG. 10), the third detection mode is triggered, so that each second mass 2 generates an in-plane vibration displacement in the X-axis direction (i.e., a vibration displacement in the datum plane). By detecting the in-plane vibration displacement of each second mass 2 in the X-axis direction, the angular velocity of the micromechanical gyroscope around the Z-axis can be obtained.

In the micromechanical gyroscope provided in this embodiment, the plurality of drivers 3 and the plurality of second masses 2 are all located in the mounting area provided by the first mass 1, and the first mass 1 surrounds the outer sides of the plurality of drivers 3 and the outer sides of the plurality of second masses 2, i.e., arranging the second masses 2 and the drivers 3 in a position where the first mass 1 has a low coriolis conversion rate, thereby improving the coriolis conversion rate of the first mass 1 and maximizing the utilization of a chip area. Thus, under equal performance, a size of the chip is reduced, and the cost is reduced.

Moreover, the high percentage of the mass shared by driving and detecting effectively improves the conversion of the coriolis force and improves the sensitivity of the micromechanical gyroscope. The micromechanical gyroscope has a simple structure, which facilitates small-size integration and reduces the cost under limited process conditions.

The drive mode of the micromechanical gyroscope is differential driving, which can effectively improve the driving stability and the anti-shock characteristics of the micromechanical gyroscope.

In addition, vibration out of phase is implemented in all the three detection modes of the micromechanical gyroscope, so that the influence of the acceleration shock and quadrature error can be effectively avoided.

Specifically, in a direction perpendicular to a front surface of the first mass 1, the projection of the first mass 1 is a centrosymmetric pattern, where the plurality of drivers 3 are symmetrical to each other in the first direction X, and the plurality of second masses 2 are symmetrical to each other in the first direction X. Such configuration facilitates differential detection of the micromechanical gyroscope.

FIG. 1 is a front view of the micromechanical gyroscope, where the direction perpendicular to the front surface of the first mass 1 is the Z-axis direction in FIG. 1, and the projection of the first mass 1 is the centrosymmetric pattern. That is, as exemplarily illustrated in FIG. 1, the projection of the first mass 1 is symmetric about the X-axis and the Y-axis respectively.

Further, the first mass 1 includes a plurality of first motion portions 11, which are uniformly disposed on the outer sides of the plurality of drivers 3 and the outer sides of the plurality of second masses 2. Each driver 3 includes a plurality of driving portions 31, which are symmetrical to each other in the second direction Y perpendicular to the first direction X. Each second mass 2 includes a plurality of second motion portions 21, which are symmetrical to each other in the second direction Y. A respective driving portion 31 of the plurality of driving portions 31 is disposed between a respective first motion portion 11 and a second motion portion 21 adjacent to the respective first motion portion 11, the respective driving portion 31 is connected to the respective first motion portion 11 by means of a respective first flexible beam 51, and the respective driving portion 31 is connected to the second motion portion 21 by means of a respective second flexible beam 52. Such configuration is more beneficial to differential detection of the micromechanical gyroscope.

For example, as shown in FIG. 1, the first mass 1 includes four first motion portions 11, where two first motion portions 11 on the upper side of the figure are symmetrical to each other about the Y-axis, two first motion portions 11 on the lower side of the figure are symmetrical to each other about the Y-axis, and the two first motion portions 11 on the upper side of the figure are symmetrical to the two first motion portions 11 on the lower side of the figure about the X-axis. Each second mass 2 includes two second motion portions 21, which are symmetrical to each other about the X-axis; and each driver 3 includes two driving portions 31, which are symmetrical to each other about the X-axis,

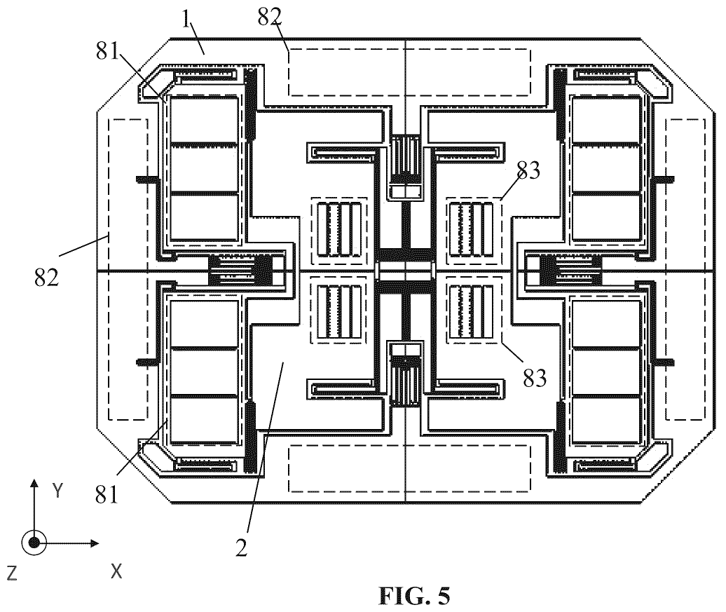

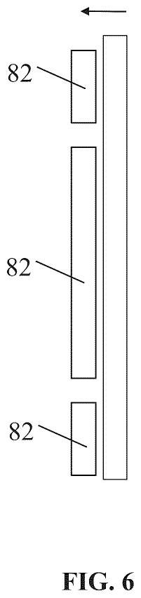

In one implementation, as shown in FIG. 5 and FIG. 6, the micromechanical gyroscope further includes a plurality of in-plane driving transducers 81 (also referred to as in-plane driving electrodes), a plurality of out-of-plane detecting transducers 82 (also referred to as out-of-plane detecting electrodes), and a plurality of in-plane detecting transducers 83 (also referred to as in-plane detecting electrodes). A respective in-plane driving transducer 81 of the plurality of in-plane driving transducers 81 is disposed above a respective driver 3 of the plurality of drivers 3, a respective in-plane detecting transducer 83 of the plurality of drivers 3 is disposed above a respective second mass 2 of the plurality of second masses 2, and the plurality of out-of-plane detecting transducers 82 are disposed above the first mass 1.

When the micromechanical gyroscope is subjected to the angular velocity in the X-axis direction, and the first mass 1 is subjected to the action of the coriolis force in the Z-axis direction, the first detection mode is triggered, and the first mass 1 generates vibration displacements in the Z-axis direction. At this time, out-of-plane detecting transducers 82 of the plurality of out-of-plane detecting transducers 82, which are disposed above the two opposite sides of the first mass 1 in the X-axis direction, detect the vibration displacements of the first mass 1 in the Z-axis direction generated on the two opposite sides of the first mass 1 in the X-axis direction, thereby obtaining the angular velocity of the micromechanical gyroscope around the X-axis.

When the micromechanical gyroscope is subjected to the angular velocity in the Y-axis direction, and the first mass 1 is subjected to the action of the coriolis force in the Z-axis direction, the second detection mode is triggered, and the first mass 1 generates vibration displacements in the Z-axis direction. At this time, out-of-plane detecting transducers 82 of the plurality of out-of-plane detecting transducers 82, which are disposed above the two opposite sides of the first mass 1 in the Y-axis direction, detect the vibration displacements of the first mass 1 in the Z-axis direction generated on the two opposite sides of the first mass 1 in the Y-axis direction, thereby obtaining the angular velocity of the micromechanical gyroscope around the Y-axis.

When the micromechanical gyroscope is subjected to the angular velocity in the Z-axis direction, and a respective second mass 2 is subjected to the action of the coriolis force in the X-axis direction, the third detection mode is triggered, and the respective second mass 2 generates a vibration displacement in the X-axis direction. At this time, a respective out-of-plane detecting transducer 82 of the plurality of out-of-plane detecting transducers 82, which is disposed above the respective second mass 2, detects the vibration displacement of the respective first mass 1 in the X-axis direction, thereby obtaining the angular velocity of the micromechanical gyroscope around the Z-axis.

In one implementation, as shown in FIG. 5, two out-of-plane detecting transducers 82 are provided for the first mass 1 in the X-axis direction, and another two out-of-plane detecting transducers 82 are provided for the first mass 1 in the Y-axis direction, where the two out-of-plane detecting transducers 82 in the X-axis direction direction are symmetrical to each other, and the two out-of-plane detecting transducers 82 in the Y-axis direction are symmetrical to each other. Two in-plane driving transducers 81 are respectively disposed above two driving portions 31 of each driver 3 in the Y-axis direction, the two in-plane driving transducers 81 in the Y-axis direction are symmetrical to each other, and in-plane driving transducers 81 disposed above one driver 3 in the X-axis direction are symmetrical to in-plane driving transducers 81 disposed above another driver 3 in the X-axis direction. Two in-plane detecting transducers 83 are respectively disposed above two second motion portions 21 of each second mass 2 in the Y-axis direction, the two in-plane detecting transducers 83 in the Y-axis direction are symmetrical to each other, and in-plane detecting transducers 83 disposed above one second mass 2 in the X-axis direction are symmetrical to in-plane detecting transducers 83 disposed above another second mass 2 in the X-axis direction.

In the direction perpendicular to the front surface of the first mass 1, the projection of the first mass 1 is the centrosymmetric pattern, where the plurality of drivers 3 are symmetrical to each other in the first direction X, and the plurality of second masses 2 are symmetrical to each other in the first direction X. That is, in the micromechanical gyroscope provided in this embodiment, the first mass 1, the second masses 2, the drivers 3, the in-plane driving transducers 81, the in-plane detecting transducers 83 and the out-of-plane detecting transducers 82 are all in a symmetrical layout, which facilitates differential detection of the micro-mechanical gyroscope.

In one implementation, referring to FIGS. 1-3, the micromechanical gyroscope further includes a first anchor point 41, a plurality of second anchor points 42, a plurality of third anchor points 43, a plurality of third flexible beams 53, and a plurality of fourth flexible beams 54. The first anchor point 41, the plurality of second anchor points 42 and the plurality of third anchor points 43 are all disposed in the mounting area. The first anchor point 41 and the plurality of second anchor points 42 are disposed between the plurality of second masses 2, and in the second direction Y perpendicular to the first direction X, the plurality of second anchor points 42 are disposed on two opposite sides of the first anchor point 41 respectively. A respective third anchor point 43 is disposed on a side of a respective driver 3 facing a respective second mass 2, and the plurality of third anchor points 43 are disposed opposite to each other in the first direction X. A respective second mass 2 is connected to the first anchor point 41 by means of a respective third flexible beam 53, and the first mass 1 is connected to the plurality of second anchor points 42 and the plurality of third anchor points 43 by means of the plurality of fourth flexible beams 54.

For example, as shown in FIG. 1, the first anchor point 41 is located in the centre of the mounting area, two second anchor points 42 are located on opposite sides of the first anchor point 41 in the Y-axis, and two third anchor points 43 are located on opposite sides of the first anchor point 41 in the X-axis. Each of the two second masses 2 located on two sides of the Y-axis is connected to the first anchor point 41, two opposite sides of the first mass 1 in the Y-axis direction are connected to two second anchor points 42 respectively, and two opposite sides of the first mass 1 in the X-axis direction is connected to two third anchor points 43 respectively.

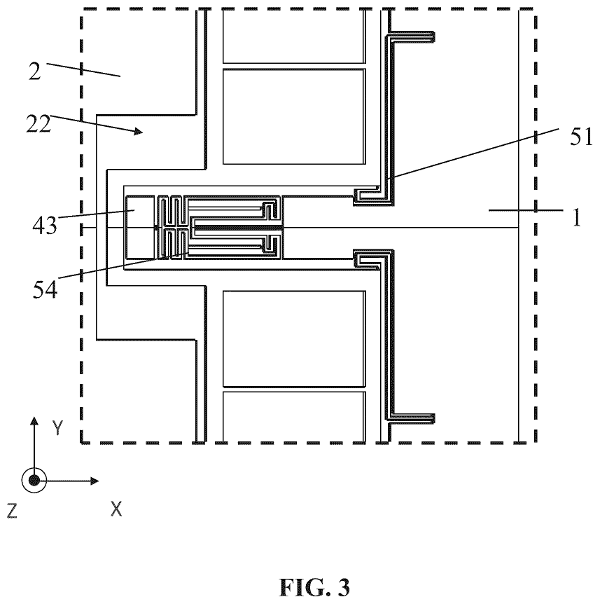

Specifically, as shown in FIGS. 1 and 3, an avoidance space 22 is provided on a side of a respective second mass 2 facing a respective driver 3, and a respective third anchor point 43 is disposed in the avoidance space 22. Such configuration facilitates making the micromechanical gyroscope compact.

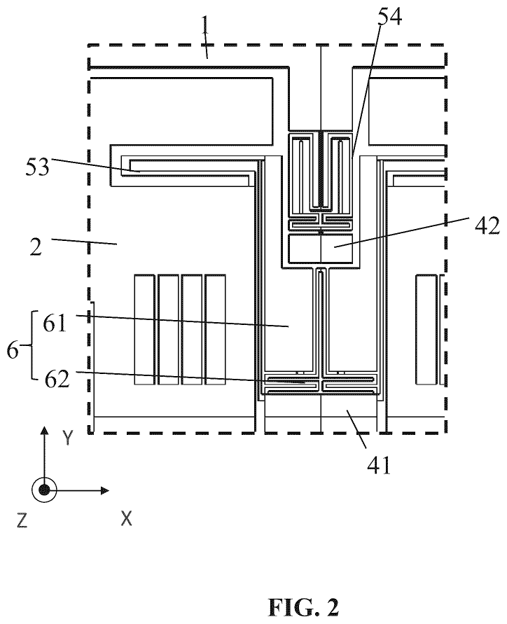

In addition, as shown in FIG. 2, the micromechanical gyroscope further includes a plurality of coupling members 6 disposed between the second masses 2. In the second direction Y, the plurality of coupling members 6 are disposed on two opposite sides of the first anchor point 41 respectively, a respective second mass 2 is connected to one end of a respective coupling member 6 by means of a respective third flexible beam 53, and the other end of the respective coupling member 6 is connected to the first anchor point 41.

Specifically, each coupling member 6 includes a coupling block 61 and a coupling beam 62. A respective second mass 2 is connected to one end of a respective coupling block 61 via a respective third flexible beam 53, and the other end of the respective coupling block 61 is connected to the first anchor point 41 via a respective coupling beam 62.

For example, as shown in FIG. 1, two coupling members 6 disposed opposite to each other in the X-axis direction are provided on each of two opposite sides of the first anchor point 41. In the same second mass 2, a second motion portion 21 on the upper side of the figure is connected to one end of one coupling block 61 adjacent to the second motion portion 21 on the upper side by means of one third flexible beam 53, with another end of the one coupling block 61 connected to the first anchor point 41 by means of one coupling beam 62; and a second motion portion 21 on the lower side of the figure is connected to one end of another coupling block 61 adjacent to the second motion portion 21 on the lower side by means of another third flexible beam 53, with another end of the another coupling block 61 connected to the first anchor point 41 by means of another coupling beam 62.

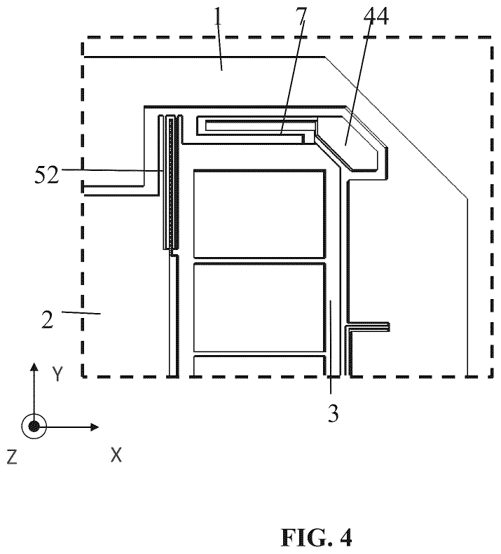

In one implementation, referring to FIGS. 1 and 4, the micromechanical gyroscope further includes a plurality of fourth anchor points 44 and a plurality of guiding beams 7. The plurality of fourth anchor points 44 are all located in the mounting area and are distributed in a circumferential direction of the mounting area. A respective fourth anchor point 44 of the plurality of fourth anchor points 44 is provided between a respective driver 3 and the first mass 1, and the respective driver 3 is connected to the respective fourth anchor point 44 by means of a respective guiding beam 7 of the plurality of guiding beams 7.

For example, as shown in FIG. 1, four fourth anchor points 44 are provided at four corner positions of the mounting area respectively, a rectangle is formed by connecting adjacent two ones of the four fourth anchor points 44, and a respective fourth anchor point 44 is connected to a respective driver 3 adjacent to the respective fourth anchor point 44 by means of a respective guiding beam 7.

Embodiments of the present disclosure further provide an electronic product. The electronic product includes a body and the micromechanical gyroscope in any of the above embodiments, the micromechanical gyroscope being mounted on the body.

During the operation of the electronic product, the micromechanical gyroscope is able to calculate an angular velocity of the electronic product, so as to facilitate the control of the electronic product. In such micromechanical gyroscope, the coriolis conversion rate of the first mass 1 is improved, and the utilization of the chip area can be maximized, so that under equal performance, the size of the chip is reduced and the cost is reduced.

The preceding implementations are merely specific embodiments for implementing the present disclosure, and it should be noted that for a person of ordinary skill in the art, improvements may be made without departing from the inventive concept of the present disclosure, and all fall within the protection scope of the present disclosure.

What is claimed is:

1. A micromechanical gyroscope, comprising:
a first mass, provided with a mounting area;
a plurality of second masses, distributed in a first direction;
a plurality of drivers, distributed in first direction, and a respective driver of a plurality of drivers is disposed on a respective one of two opposite sides of the plurality of second masses in first direction, wherein the plurality of drivers and the plurality of second masses are all located within the mounting area, and the first mass surrounds outer sides of the plurality of drivers and outer sides of the plurality of second masses;
a plurality of first flexible beams, wherein the respective driver of the plurality of drivers is connected to the first mass by means of a respective first flexible beam of the plurality of first flexible beams; and
a plurality of second flexible beams, wherein a respective second mass of the plurality of second masses is connected to the respective driver of the plurality of drivers adjacent to the respective second mass by means of a respective second flexible beam of the plurality of second flexible beams.

2. The micromechanical gyroscope of claim 1, wherein in a direction perpendicular to a front surface of the first mass, a projection of the first mass is a centrosymmetric pattern; and the plurality of drivers are symmetrical to each other in the first direction, and the plurality of second masses are symmetrical to each other in the first direction.

3. The micromechanical gyroscope of claim 2, wherein the first mass includes a plurality of first motion portions, which are uniformly disposed on the outer sides of the plurality of drivers and the outer sides of the plurality of second masses;
each of the plurality of drivers includes a plurality of driving portions symmetrical to each other in a second direction perpendicular to the first direction, and each of the plurality of second masses includes a plurality of second motion portions symmetrical to each other along the second direction; and
a respective driving portion of the plurality of driving portions is provided between a respective first motion portion of the plurality of first motion portions and one of the plurality of second motion portions adjacent to the respective first motion portion, the respective driving portion is connected to the respective first motion portion by means of a respective one of the plurality of first flexible beams, and the respective driving portion is connected to the one of the plurality of second motion portions by means of a respective one of the plurality of second flexible beams.

4. The micromechanical gyroscope of claim 1, wherein the micromechanical gyroscope further includes a first anchor point, a plurality of second anchor points, a plurality of third anchor points, a plurality of third flexible beams and a plurality of fourth flexible beams; the first anchor point, the plurality of second anchor points and the plurality of third anchor points are all located in the mounting area; the first anchor point and the plurality of second anchor points are disposed between the plurality of second masses, and the plurality of second anchor points are disposed on two opposite sides of the first anchor point in a second direction perpendicular to the first direction; a respective third anchor point of the plurality of third anchor points is disposed on a side of the respective driver of the plurality of drivers facing the respective second mass of the plurality of second masses, and the plurality of third anchor points are disposed opposite to each other in the first direction; and
the respective second mass of the plurality of second masses is connected to the first anchor point by means of a respective third flexible beam of the plurality of third flexible beams, and the first mass is connected to the plurality of second anchor points and the plurality of third anchor points by means of the plurality of fourth flexible beams.

5. The micromechanical gyroscope of claim 4, wherein an avoidance space is provided on a side of the respective second mass of the plurality of second masses facing the respective driver of the plurality of drivers, and the respective third anchor point is located in the avoidance space.

6. The micromechanical gyroscope of claim 4, wherein the micromechanical gyroscope further includes a plurality of coupling parts between the plurality of second masses; in the second direction, the plurality of coupling parts are disposed on two opposite sides of the first anchor respectively; the respective second mass of the plurality of second masses is connected to one end of a respective coupling part of the plurality of coupling parts by means of the respective third flexible beam of the plurality of third flexible beams, and another end of the respective coupling part is connected to the first anchor point.

7. The micromechanical gyroscope of claim 6, wherein the respective coupling part includes a coupling block and a coupling beam, and the respective second mass of the plurality of second masses is connected to one end of the coupling block by means of the respective third flexible beam, and another end of the coupling block is connected to the first anchor point.

8. The micromechanical gyroscope of claim 1, further including:
a plurality of fourth anchor points and a plurality of guiding beams, wherein the plurality of fourth anchor points are located in the mounting area and distributed in a circumferential direction of the mounting area, a respective fourth anchor point of the plurality of fourth anchor points is disposed between the first mass and the respective driver of the plurality of drivers, and the respective driver is connected to the respective fourth anchor point by means of a respective guiding beam of the plurality of guiding beams.

9. The micromechanical gyroscope of claim 1, further including:
a plurality of in-plane driving transducers, wherein a respective in-plane driving transducer of the plurality of in-plane driving transducers is disposed above the respective driver of the plurality of drivers;
a plurality of in-plane detecting transducers, wherein a respective in-plane detecting transducer of the plurality of in-plane detecting transducers is disposed above the respective second mass of the plurality of second masses; and
a plurality of out-of-plane detecting transducers, disposed above the first mass.

10. The micromechanical gyroscope of claim 2, further including:
a plurality of fourth anchor points and a plurality of guiding beams, wherein the plurality of fourth anchor points are located in the mounting area and distributed in a circumferential direction of the mounting area, a respective fourth anchor point of the plurality of fourth anchor points is disposed between the first mass and the respective driver of the plurality of drivers, and the respective driver is connected to the respective fourth anchor point by means of a respective guiding beam of the plurality of guiding beams.

11. The micromechanical gyroscope of claim 2, further including:
a plurality of in-plane driving transducers, wherein a respective in-plane driving transducer of the plurality of in-plane driving transducers is disposed above the respective driver of the plurality of drivers;
a plurality of in-plane detecting transducers, wherein a respective in-plane detecting transducer of the plurality of in-plane detecting transducers is disposed above the respective second mass of the plurality of second masses; and
a plurality of out-of-plane detecting transducers, disposed above the first mass.

12. An electronic product, comprising:
a body; and
a micromechanical gyroscope, mounted on the body,
wherein the micromechanical gyroscope includes:
a first mass, provided with a mounting area;
a plurality of second masses, distributed in a first direction;
a plurality of drivers, distributed in first direction, and a respective driver of a plurality of drivers is disposed on a respective one of two opposite sides of the plurality of second masses in first direction, wherein the plurality of drivers and the plurality of second masses are all located within the mounting area, and the first mass surrounds outer sides of the plurality of drivers and outer sides of the plurality of second masses;
a plurality of first flexible beams, wherein the respective driver of the plurality of drivers is connected to the first mass by means of a respective first flexible beam of the plurality of first flexible beams; and
a plurality of second flexible beams, wherein a respective second mass of the plurality of second masses is connected to the respective driver of the plurality of drivers adjacent to the respective second mass by means of a respective second flexible beam of the plurality of second flexible beams.

13. The electronic product of claim 12, wherein in a direction perpendicular to a front surface of the first mass, a projection of the first mass is a centrosymmetric pattern; and
the plurality of drivers are symmetrical to each other in the first direction, and the plurality of second masses are symmetrical to each other in the first direction.

14. The electronic product of claim 13, wherein the first mass includes a plurality of first motion portions, which are uniformly disposed on the outer sides of the plurality of drivers and the outer sides of the plurality of second masses;
each of the plurality of drivers includes a plurality of driving portions symmetrical to each other in a second direction perpendicular to the first direction, and each of the plurality of second masses includes a plurality of second motion portions symmetrical to each other along the second direction; and
a respective driving portion of the plurality of driving portions is provided between a respective first motion portion of the plurality of first motion portions and one of the plurality of second motion portions adjacent to the respective first motion portion, the respective driving portion is connected to the respective first motion portion by means of a respective one of the plurality of first flexible beams, and the respective driving portion is connected to the one of the plurality of second motion portions by means of a respective one of the plurality of second flexible beams.

15. The electronic product of claim 12, wherein the micromechanical gyroscope further includes a first anchor point, a plurality of second anchor points, a plurality of third anchor points, a plurality of third flexible beams and a plurality of fourth flexible beams; the first anchor point, the plurality of second anchor points and the plurality of third anchor points are all located in the mounting area; the first anchor point and the plurality of second anchor points are disposed between the plurality of second masses, and the plurality of second anchor points are disposed on two opposite sides of the first anchor point in a second direction perpendicular to the first direction; a respective third anchor point of the plurality of third anchor points is disposed on a side of the respective driver of the plurality of drivers facing the respective second mass of the plurality of second masses, and the plurality of third anchor points are disposed opposite to each other in the first direction; and
the respective second mass of the plurality of second masses is connected to the first anchor point by means of a respective third flexible beam of the plurality of third flexible beams, and the first mass is connected to the plurality of second anchor points and the plurality of third anchor points by means of the plurality of fourth flexible beams.

16. The electronic product of claim 15, wherein an avoidance space is provided on a side of the respective second mass of the plurality of second masses facing the respective driver of the plurality of drivers, and the respective third anchor point is located in the avoidance space.

17. The electronic product of claim 15, wherein the micromechanical gyroscope further includes a plurality of coupling parts between the plurality of second masses; in the second direction, the plurality of coupling parts are disposed on two opposite sides of the first anchor respectively; the respective second mass of the plurality of second masses is connected to one end of a respective coupling part of the plurality of coupling parts by means of the respective third flexible beam of the plurality of third flexible beams, and another end of the respective coupling part is connected to the first anchor point.

18. The electronic product of claim 17, wherein the respective coupling part includes a coupling block and a coupling beam, and the respective second mass of the plurality of second masses is connected to one end of the coupling block by means of the respective third flexible beam, and another end of the coupling block is connected to the first anchor point.

19. The electronic product of claim 12, wherein the micromechanical gyroscope further includes:
a plurality of fourth anchor points and a plurality of guiding beams, wherein the plurality of fourth anchor points are located in the mounting area and distributed in a circumferential direction of the mounting area, a respective fourth anchor point of the plurality of fourth anchor points is disposed between the first mass and the respective driver of the plurality of drivers, and the respective driver is connected to the respective fourth anchor point by means of a respective guiding beam of the plurality of guiding beams.

20. The electronic product of claim 12, wherein the micromechanical gyroscope further includes:
a plurality of in-plane driving transducers, wherein a respective in-plane driving transducer of the plurality of in-plane driving transducers is disposed above the respective driver of the plurality of drivers;
a plurality of in-plane detecting transducers, wherein a respective in-plane detecting transducer of the plurality of in-plane detecting transducers is disposed above the respective second mass of the plurality of second masses; and
a plurality of out-of-plane detecting transducers, disposed above the first mass.
